(19) United States
(12) Patent Application Publication
(10) Pub. No.: US 2011/0162464 A1
(43) Pub. Date: Jul. 7, 2011

(54) Reduced Ambient Fields Error In A Magnetoelastic Torque Sensor System

(75) Inventor: Wensheng Weng, Canton, MI (US)

(73) Assignee: SMTS LLC, Livonia, MI (US)

(21) Appl. No.: 12/651,469

(22) Filed: Jan. 2, 2010

(51) Int. Cl. G01L 3/10

(52) U.S. Cl. 73/862.333

(57) ABSTRACT

An improved magnetic torque transducer involves a method and apparatus for compensating effects of uniform and/or non-uniform magnetic sources by placing three sets of magnetic field sensors around a shaft with at least one magnetized zone. The set of primary magnetic field sensor or sensors is placed proximate to the magnetized zone, both the second and third sets of secondary magnetic field sensors being placed by pre-determined distances to the primary set of magnetic field sensor or sensors, so that primary field sensors always in a position with higher magnetic field strength arise from applied torque than that of secondary sensors. And a method is developed to use the second and third signals from secondary sensors to adjust the primary signal to compensating for the effects of the uniform and/or non-uniform ambient magnetic field sources.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to the field of using magnetic sensors to measure torque applied to a shaft. More particularly, the invention is related to systems, methods, and apparatus involving sensors and circuits that reduce ambient magnetic fields effects while measuring torque-induced magnetic fields.

### BACKGROUND OF THE INVENTION

Magnetic torque sensors are known in the art. Many versions of this type of magnetoelastic torque sensor have been proposed and described in a plurality of publications and patent specifications. These sensor systems are contactless in that a transducer element generating a torque-dependent magnetic field rotates with a shaft. The torque-dependent magnetic field is sensed by a sensor or sensor assembly that is not in contact with the rotating parts.

In practical usages, a torque sensor is exposed to ambient magnetic fields, there are numerous types of ambient magnetic fields, and these ambient sources can combine with torque-induced magnetic fields and lead to false torque reading. Thus, it is important to eliminate effects of ambient magnetic sources.

Accordingly, it is desirable to create a more accurate configuration for the magnetic sensors to reduce torque measurement error due to ambient magnetic sources and environment variables.

### SUMMARY OF THE INVENTION

The present invention was devised to provide a magnetoelastic torque transducer by arranging the magnetic torque sensors in a manner and signal process means that minimizes the amount of error caused by ambient magnetic fields.

A torque sensor comprising at least one magnetoelastically active element, and three sets of magnetic field sensors are placed above magnetic region, or regions, conditioned on a shaft. A first or primary set of magnetic field sensor or sensors is located above the magnetically conditioned region or regions, responsive to the field of the magnetoelastically active portion arise from applied torque. A second set of secondary magnetic field sensor or sensors is placed next to the first set of magnetic field sensor or sensors axially, with less sensitivity to fields generated by the same torque. And a third set of secondary magnetic field sensor or sensors is placed next to the second set of secondary magnetic field sensor or sensors further away from first or primary set of sensor or sensors along the axis, so that the second set of field sensors is between first and third set of field sensors. The third set of secondary sensor or sensors has the same the sensitivity to the interested magnetic fields generated by applied torque as that of the second set of secondary field sensor or sensors.

The magnetic field sensor or sensors in a magnetoelastic torque sensor system respond to all magnetic fluxes pass through these field sensors, including fields generated by interested torque and unwanted ambient fields. There are two types of ambient fields, uniform (far field) and non-uniform (near field). A uniform field would affect each of the corresponding field sensors with equal magnitude, thus its effects can be effective cancel out by using common mode rejection method. The non-uniform fields expose each of the magnetic field sensors along the shaft axis to distinctly different field intensities and direction.

Three sets of magnetic field sensors form a torque sensor, the primary set of field sensor or sensors has higher sensitivity to the interested magnetic fields generated by applied torque than the two secondary sets of field sensor or sensors. The signals of these three sets of sensor or sensors is bring out and processed separately to cancel out effects of ambient fields.

All these three sets of field sensors also subject to ambient fields, they have the same signal output under uniform ambient fields, while they respond differently with different output signals to non-uniform near ambient fields, the set of field sensor or sensors closest to the interfering magnetic source has the largest signal output while the farthest set of field sensor or sensors has the smallest signal output.

By comparing output signals of the second and third set of secondary sensor or sensors, S₂ and S₃ respectively, it can be determined from which side non-uniform ambient fields come from. If S₃ is bigger than S₂, it indicates that resulting non-uniform field sources is closest to third set of secondary sensor or sensors, and the primary set of sensor or sensors would have the smallest signal output from the non-uniform fields. On the other hand, if S₃ is smaller than S₂, it indicate that non-uniform field sources come from the side of the set of primary sensor or sensors, thus the primary set of sensor or sensors would have the largest signal output from the non-uniform field among the three set of field sensors.

By subtracting output signals of the third set of secondary sensor or sensors from that of the second set, the resulting signal (S₂−S₃) is the difference of the non-uniform fields effect on the third set of secondary sensor or sensors and the second set of secondary sensor or sensors, because they have the same output signals respond to both the fields cause by torque and uniform ambient fields. This signal (S₂−S₃) has a known relationship to the difference of effects of non-uniform fields on primary and second set of field sensors once the torque sensor system is known, so it can be used to compensate for the effects of non-uniform ambient fields on the primary set of field sensor or sensors.

Now subtract output signals of the second set of secondary sensor or sensors from that of the primary set, the resulting signal (Sₚ−S₂) contain torque signal Sₜ and the difference of effects of non-uniform fields on primary and second set of field sensors, because there is known relationship between that and (S₂−S₃), thus the torque signal Sₜ can be obtained by subtract α*(S₂−S₃) from (Sₚ−S₂). Where α is a constant and is determined by the configuration of each particular magnetoelastic torque sensor system.

Secondary field sensor or sensors may also be placed approximate to the active magnetoelastic zone with lower field strength than that of primary set of field sensor or sensors.

Alternatively, sets of secondary field sensor or sensors may be placed on both sides of primary set of field sensor or sensors instead of one side.

In addition to the placement of two sets of secondary field sensors so that their sensitivity to the magnetic fields arise from applied torque is equal to each other as disclosed above, this signal process means can be applicable to placement of two sets secondary field sensors so that their sensitivity to the magnetic fields arise from applied torque is different than each other.

### BRIEF DESCRIPTION OF THE DRAWING

FIG. 1 shows a primary magnetic field sensor is subjected to magnetic fields arise from applied torque, uniform ambient magnetic fields and non-uniform ambient magnetic fields.

FIG. 2 shows a 2-dimensional representation of the present invention.

FIG. 3 shows alternative embodiments of the torque transducer.

FIG. 4 shows another alternative embodiments of the torque transducer.

FIG. 5 shows yet another alternative embodiments of the torque transducer.

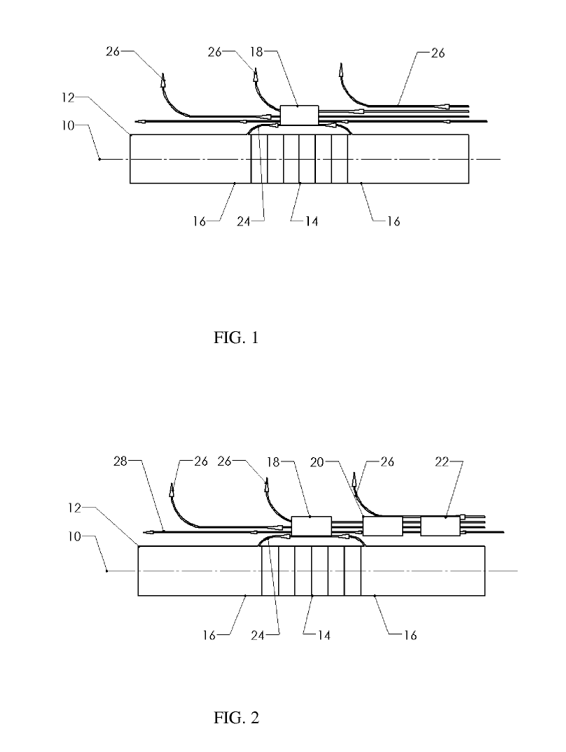

### DRAWINGS

### Reference Numerals

| | | | |
|---|---|---|---|
| 10 | Axis | 12 | Shaft |
| 14 | Active Magnetoelastic zone | 16 | Magnetic Passive Area |
| 18 | Primary Field Sensor(s) | 20 | Secondary Field Sensor(s) |
| 22 | Secondary Field Sensor(s) | 24 | Magnetic Flux Dependent On |
| | | | Torque |
| 26 | Non-uniform Ambient | 28 | Uniform Ambient Magnetic Flux |
| | Magnetic Flux | | |

### DESCRIPTION OF THE PREFERRED EMBODIMENTS

FIG. 2 illustrates a preferred embodiment of a magnetoelastic torque sensing apparatus in accordance with the invention. In this exemplary embodiment, the torque carrying shaft 12 having a torque T applied about a central longitudinal axis 10, the shaft 12 has an magnetoelastically active portion 14, one set of primary field sensor or sensors 18 is placed approximate to this magnetoelastically active portion 14 to detect the magnetic flux 24 arise from applied torque, and one set of secondary field sensor or sensors 20, is placed next to primary set of field sensor or sensors 18 axially, another set of secondary field sensor or sensors 22 is placed in the same direction farther away axially so both the second and third sets of secondary sensor or sensors on the same side of the primary set of field sensor or sensors 18. Sensors 20 and 22 are disposed in such a way that they are far away enough from magnetoelastically active portion 14 to avoid the magnetic flux 24 dependent on applied torque T.

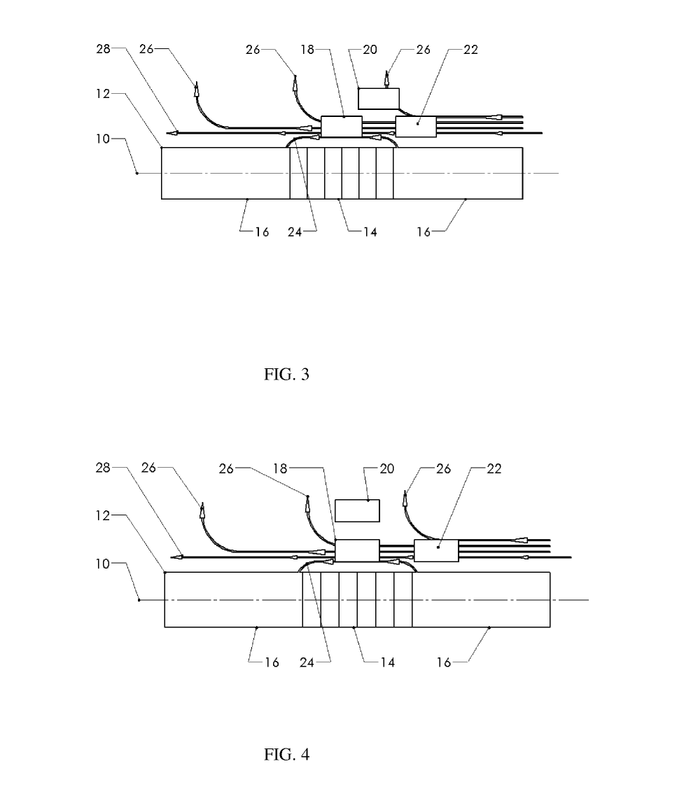

FIG. 3 shows an alternative arrangement of these three sets of field sensors. In this arrangement, the third set of secondary field sensor or sensors 22 is placed next to the primary set of sensor or sensors 18 axially, in a position with a lower sensitivity to the magnetic fields dependent on applied torque, and the second set of secondary field sensor or sensors 20 is placed between the primary and the third secondary set of field sensor or sensors 22, but farther away from shaft 12 radially, so that the second secondary set of field sensor or sensors 20 will have the same sensitivity to magnetic fields arise from applied torque as that of third set of secondary sensor or sensors 22.

The arrangement in FIG. 4 is similar to that of FIG. 3, except that the second set of secondary field sensor or sensors has the same axial position as that of primary set of field sensor or sensors, but farther away from shaft 12 radically.

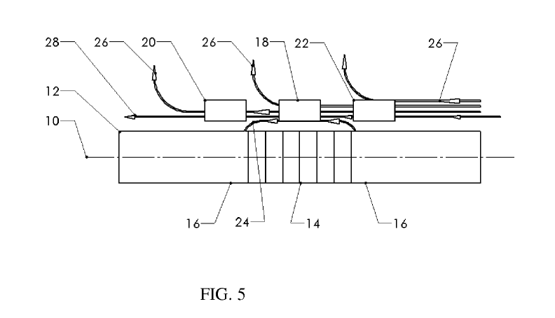

FIG. 5 shows another alternative arrangement of these three sets of field sensors. In this arrangement, the second set of secondary field sensor or sensors 20 is placed next to the primary set of sensor or sensors 18 axially, in a position with a lower sensitivity to the magnetic fields dependent on applied torque, and the third set of secondary field sensor or sensors 22 is placed on the opposite direction, and the third secondary set of field sensor or sensors 22 will have the same sensitivity to magnetic fields arise from applied torque as that of second set of secondary sensor or sensors 20.

The outputs of these three sets of field sensor or sensors 18, 20 and 22 are brought out separately, thus their value are known, and output of primary set of sensor or sensors 18 composes of:

Sₚ=Sₚₜ+Sₚᵤ+Sₚₙ

### Where

Sₚ=Total signal output of primary set of field sensor or sensors 18.
Sₚₜ=Output components of set of primary field sensor or sensors 18 cause by applied torque.
Sₚᵤ=Output components of set of primary field sensor or sensors 18 cause by uniform ambient fields.
Sₚₙ=Output components of set of primary field sensor or sensors 18 cause by non-uniform ambient fields.

Output of the second set of secondary sensor or sensors 20 can be expressed as following:

S₂=Sₜ₂+Sᵤ₂+Sₙ₂

### Where

S₂=Total signal output of secondary set of field sensor or sensors 20.
Sₜ₂=Output components of set of secondary field sensor or sensors 20 cause by applied torque.
Sᵤ₂=Output components of set of secondary field sensor or sensors 20 cause by uniform ambient fields.
Sₙ₂=Output components of set of secondary field sensor or sensors 20 cause by non-uniform ambient fields.

And output of the third set of secondary sensor or sensors 22 can be expressed as following:

S₃=Sₜ₃+Sᵤ₃+Sₙ₃

### Where

S₃=Total signal output of secondary set of field sensor or sensors 22.
Sₜ₃=Output components of set of secondary field sensor or sensors 22 cause by applied torque.
Sᵤ₃=Output components of set of secondary field sensor or sensors 22 cause by uniform ambient fields.
Sₙ₃=Output components of set of secondary field sensor or sensors 22 cause by non-uniform ambient fields.

In these output signals, the torque signals Sₚₜ of primary set of field sensor or sensors is always bigger than that of second and third set of secondary field sensor or sensors. (Sₜ₂ and Sₜ₃), and Sₚₜ is proportional to Sₜ₂ or Sₜ₃.

In arrangements mentioned above, Sₜ₂=Sₜ₃. And the uniform ambient fields signals for all three set of field sensor or sensors are the same. Thus, the difference between output signals of second and third sets of secondary field sensor or sensors are the effect of non-uniform ambient fields on these two sets of field sensors. And its value can be obtained by subtracting the third signal from the second signal:

(S₂−S₃)=Sₙ₂−Sₙ₃

Because the configuration of three sets of field sensors is always known in a particular torque sensor, the relationship of effect of non-uniform ambient fields on these three set of field sensors can also be known.

If total output signals of the second set of secondary field sensor or sensors is bigger than that of the third set of secondary field sensor or sensors, it indicates that second set of secondary field sensor or sensors is closest to resulting non-uniform fields, thus the second set of sensor or sensors has the biggest non-uniform ambient fields signal. If total output signals of second set of secondary field sensor or sensors is smaller than that of third set of secondary field sensor or sensors, it indicates that the primary set of field sensor or sensors (FIG. 2, FIG. 3 and FIG. 4) or the third set of field sensor or sensors (FIG. 5) is closest to resulting non-uniform fields, and thus the primary set of field sensor or sensors has the biggest non-uniform ambient fields signal. If Sₙ₃=Sₙ₂, it indicates that there is no non-uniform ambient fields.

Now subtract output signals of second set of secondary field sensor or sensors from that of primary set of sensor or sensors, the following can be obtained: Sₚ−S₂=(Sₚₜ−Sₜ₂)+(Sₚₙ−Sₙ₂)

In this equation, Sₚ and S₂ are known value, and the non-uniform ambient fields signals Sₚₙ−S₂ₙ is proportional to known value Sₙ₃−Sₙ₂, so the value of torque Sₜ applied on the shaft 12 can be calculated by the following formula:

Sₜ=Sₚₜ−S₂ₜ=(Sₚ−S₂)+(Sₚₙ−Sₙ₂)

Sₜ=(Sₚ−S₂)+α(Sₙ₃−Sₙ₂)

Where α is a constant dependent on the configuration of a particular torque sensor system.

Thus the resulting torque signals Sₜ is mostly free from the effects of uniform and/or non-uniform ambient fields.

This method also applicable to subtract output signals of third set of secondary field sensor or sensors instead of that of second set from that of primary set of sensor or sensors.

In addition to the placement of two sets of secondary field sensors so that their sensitivity to the magnetic fields arise from applied torque is equal to each other as disclosed above, this signal process means can be applicable to placement of two sets secondary field sensors so that their sensitivity to the magnetic fields arise from applied torque is different than each other.

While certain features and embodiments of the present invention have been described in detail herein, it is to be understood that the invention encompasses all modifications and enhancements within the scope and spirit of the following claims.

I claimed:

1. A magnetic torque sensing system comprising:
A member about a longitudinal axis, operably mounted to have a torque applied to the said member.
Said member having a transducer element with at least one zone, which is either a respective integral portion of the member, or be directly or indirectly attached to or forming a part of the surface of said member.
Said zone or zones being disposed along said longitudinal axis and being magnetized, its magnetic properties varies under applied torque and it is a function of a torque applied about said longitudinal axis.
A magnetic sensor means arrangement comprising at least one primary field sensors placed proximate to the at least one region for outputting a first signal corresponding to a magnetic flux arising from the active region dependent on applied torque, at least one secondary magnetic field sensor spaced by a pre-determined first distance from the plurality of primary magnetic field sensors for outputting a second signal corresponding to ambient magnetic flux, and at least one secondary magnetic field sensor spaced in a pre-determined second distance from the plurality of primary magnetic field sensors for outputting a third signal corresponding to the ambient magnetic flux, and
Signal processing means to receive the said first signal from primary sensor or sensors; receive the said second and third signals from secondary sensors; and adjusting the first signal using the second and third signals thereby compensating for the effects of the uniform and/or non-uniform ambient magnetic field sources.

2. A torque sensor system of claim 1, wherein the second and third set of secondary field sensor or sensors has the same output signals respond to the same magnetic fields arise from applied torque.

3. A torque sensor system of claim 1, wherein the second and third set of secondary field sensor or sensors has different output signals respond to the same magnetic fields arise from applied torque.

4. A torque sensor system of claim 1, wherein at least one secondary magnetic field sensor axially spaced in a direction by a pre-determined first distance from the plurality of primary magnetic field sensors; at least one secondary magnetic field sensor axially spaced in the same direction a pre-determined second distance from the plurality of primary magnetic field.

5. A torque sensor system of claim 4, wherein the secondary set of field sensor or sensors next to the primary set of field sensor or sensors is disposed radial farther away from shaft than the other two sets of field sensors.

6. A torque sensor system of claim 1, wherein radial distances of three sets of field sensor or sensors to the surface of the shaft are the same.

7. A torque sensor system of claim 1, wherein radial distances of three sets of field sensor or sensors to the surface of the shaft are different.

8. A torque sensor system of claim 1, wherein at least one secondary magnetic field sensor axially spaced by a pre-determined first distance from the plurality of primary magnetic field sensors; at least one secondary magnetic field sensor radially spaced a pre-determined second distance from the plurality of primary magnetic field sensors.

9. A torque sensor system of claim 1, wherein at least one secondary magnetic field sensor axially spaced in a first direction by a pre-determined first distance from the plurality of primary magnetic field sensors; at least one secondary magnetic field sensor axially spaced in a second direction opposite the first direction a pre-determined second distance from the plurality of primary magnetic field sensors.

10. A torque sensor system of claim 1, wherein the magnetic field sensors are vector sensors.

11. A torque sensor system of claim 1, wherein the vector sensors are one of a Hall effect, magnetoresistance, magnetotransistor, magnetodiode, or MAGFET field sensors

12. A torque sensor system of claim 1, wherein the primary and secondary magnetic field sensors are oriented substantially normally to the surface of the shaft.

13. A torque sensor system of claim 1, wherein the primary and secondary magnetic field sensors are oriented substantially parallelly to the surface of the shaft.

14. A torque sensor system of claim 1, wherein the primary magnetic field sensors and one set of the secondary magnetic field sensors are arranged on one side of the shaft, and wherein the other set of the secondary magnetic field sensors are arranged on an opposite side of the shaft.

15. A torque sensor system of claim 1, wherein the primary magnetic field sensors are arranged on one side of the shaft, and wherein the second and third set of secondary magnetic field sensors are arranged on an opposite side of the shaft.

16. A torque sensor system of claim 1, wherein the primary magnetic field sensors and the second and third set of secondary magnetic field sensors are arranged on one side of the shaft.

17. A torque sensor system of claim 1, wherein the set of primary magnetic field sensors and the second and third set of secondary magnetic field sensors are arranged in line with each other and axisymmetric around the shaft.

18. A torque sensor system of claim 1, wherein signal processing means comprising:
receiving the first signal from the set of primary sensor or sensors.
receiving the second signal from second set of secondary sensor or sensors.
receiving the third signal from third set of secondary sensor or sensors.
determining the difference between second and third signals.
determining the difference between first signal and second or third signal.
adjusting the first signal using said signal differences and thereby compensating for the effects of the uniform and/or non-uniform ambient magnetic field source.
converting the said adjusted signal into output signal for the system.
